(19) United States
(12) Patent Application Publication
(10) Pub. No.: US 2016/0314559 A1
(43) Pub. Date: Oct. 27, 2016

(54) ELECTRONIC APPARATUS AND METHOD

(71) Applicant: KABUSHIKI KAISHA TOSHIBA, Tokyo (JP)

(72) Inventor: Kazuki Kimura, Fussa Tokyo (JP)

(21) Appl. No.: 14/931,498

(22) Filed: Nov. 3, 2015

Related U.S. Application Data
(60) Provisional application No. 62/152,629, filed on Apr. 24, 2015.

(51) Int. Cl. G06T 3/40; G06F 3/041; G06T 1/60; H04N 5/225

(52) U.S. Cl. CPC G06T 3/40; H04N 5/2257; G06F 3/0416; G06T 1/60; G06T 2207/20021

(57) ABSTRACT

According to one embodiment, an electronic apparatus includes a display, a memory configured to store resolution setting data comprising multiple enlargement ratios each of which is associated with a resolution to be set on the display, and circuitry configured to determine a first enlargement ratio for a designated resolution on the display based on the resolution setting data, and display a screen image on the display at the first enlargement ratio.

### CROSS-REFERENCE TO RELATED APPLICATIONS

This application claims the benefit of U.S. Provisional Application No. 62/152,629, filed Apr. 24, 2015, the entire contents of which are incorporated herein by reference.

### FIELD

Embodiments described herein relate generally to an electronic apparatus and a method.

### BACKGROUND

In general, tablet computers, PDAs, smartphones, etc., are widely known as electronic apparatuses including touchscreen displays.

Moreover, in recent years, computers of an intermediate type between a personal computer (PC) and a tablet computer have been developed. Such computers are called two-in-one PCs. Two-in-one PCs can be used not only in a style like a personal computer but also in a style like a tablet computer as necessary.

Incidentally, some electronic apparatuses including a touchscreen display have a function of displaying part or all of the screen image of the touchscreen display enlargingly (hereinafter, referred to as an enlarged display function). According to the enlarged display function, for example, the visibility of the touchscreen display can be improved by a simple operation (for example, a touch operation) on the touchscreen display.

However, such enlarged display is performed in a constant ratio. Thus, there are cases where the screen image of a touchscreen display cannot be appropriately displayed enlargedly, for example, when a user changes (a setting of) the resolution of the touchscreen display. Specifically, for example, if the ratio is too high as compared to the resolution of the touchscreen display, the screen image may be displayed larger than necessary. On the other hand, if the ratio is too low as compared to the resolution of the touchscreen display, the screen may not be enlarged sufficiently.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an example of an outside of an electronic apparatus in the case where the electronic apparatus according to a present embodiment is in a tablet style;

FIG. 2 is a perspective view showing a relationship between a main body and a base including a keyboard of the electronic apparatus according to the present embodiment;

FIG. 3 is a perspective view showing an example of the outside of the electronic apparatus in the case where the electronic apparatus according to the present embodiment is in a PC style;

FIG. 4 is a block diagram showing an example of a hardware structure of the electronic apparatus;

FIG. 5 is a block diagram showing an example of a functional structure of the electronic apparatus;

FIG. 6 is a diagram showing an example of a data structure of storage shown in FIG. 5;

FIG. 7 is a flowchart showing an example of a procedure of the electronic apparatus by which a screen image of a touchscreen display is displayed enlargedly by an enlarged display function;

FIG. 8 is a diagram for explaining an example of a display screen image displayed enlargedly; and

FIG. 9 is a diagram for explaining the example of the display screen image displayed enlargedly.

### DETAILED DESCRIPTION

Various embodiments will be described hereinafter with reference to the accompanying drawings.

In general, according to one embodiment, an electronic apparatus includes: a display; a memory configured to store resolution setting data comprising multiple enlargement ratios each of which is associated with a resolution to be set on the display; and circuitry configured to determine a first enlargement ratio for a designated resolution on the display based on the resolution setting data, and display a screen image on the display at the first enlargement ratio.

First, a structure of an electronic apparatus according to a present embodiment will be described with reference to FIG. 1 to FIG. 3. As shown in FIG. 1 to FIG. 3, an electronic apparatus 10 according to the present embodiment is implemented as a computer (hereinafter, referred to as a two-in-one PC) which can be used like a personal computer and also like a tablet computer.

The electronic apparatus 10 is structured, such that a main body 11 of the electronic apparatus 10 can be easily detached from a base 22 including a keyboard 23. That is, the main body 11 of the electronic apparatus 10 includes a connector 14, and is attached to the base 22 through the connector 14 to be detachable therefrom.

The base 22 is a device including the keyboard 23. Example of the device including the keyboard 23 include an attachable/detachable keyboard (keyboard base) which can be attached to (combined with) the main body 11 to be detachable therefrom.

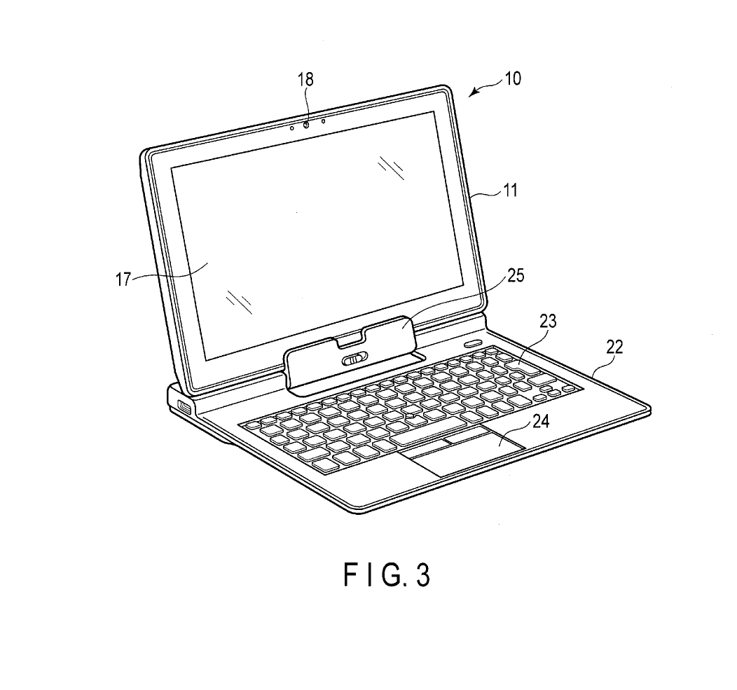

The electronic apparatus 10 can be used like a personal computer (PC) (PC style of FIG. 3). Moreover, when it is unnecessary to use a keyboard and a mouse, the electronic apparatus 10 can be used like a tablet apparatus by detaching the main body 11 of the electronic apparatus 10 from the base 22 (tablet style of FIG. 1).

Here, let us assume the case where a user uses the electronic apparatus 10 in an office. When the user is at his or her desk in the office, the user can use the electronic apparatus 10 in the PC style. On the other hand, when the user moves to, for example, a meeting room, the user can bring only the main body 11 to the meeting room by detaching the main body 11 from the base 22 and use the electronic apparatus 10 in the tablet style.

FIG. 1 shows an outside of the electronic apparatus 10 in the case where the electronic apparatus 10 is in the tablet style. As shown in FIG. 1, the electronic apparatus 10 includes the main body 11 and a touchscreen display 17. The touchscreen display 17 is attached to be superposed on a front surface of the main body 11.

The main body 11 of the electronic apparatus 10 includes a housing in the shape of a thin box. A power button 12, a USB port 13, etc., are disposed on a side surface, for example a right side surface, of the main body 11. The touchscreen display 17 incorporates a flat panel display and a sensor. The sensor detects a touch position of a pen or a finger on the screen of the flat panel display. As the sensor, for example, a capacitive touchpanel or an electromagnetic induction type digitizer can be used. The flat panel display may be, for example, a liquid crystal display (LCD).

The connector 14 for connecting the main body 11 and the base 22 mechanically and electrically is disposed at a lower end (bottom) of the main body 11 of the electronic apparatus 10.

When the electronic apparatus 10 is in the tablet style shown in FIG. 1, the touchscreen display 17 is mainly used as an input device.

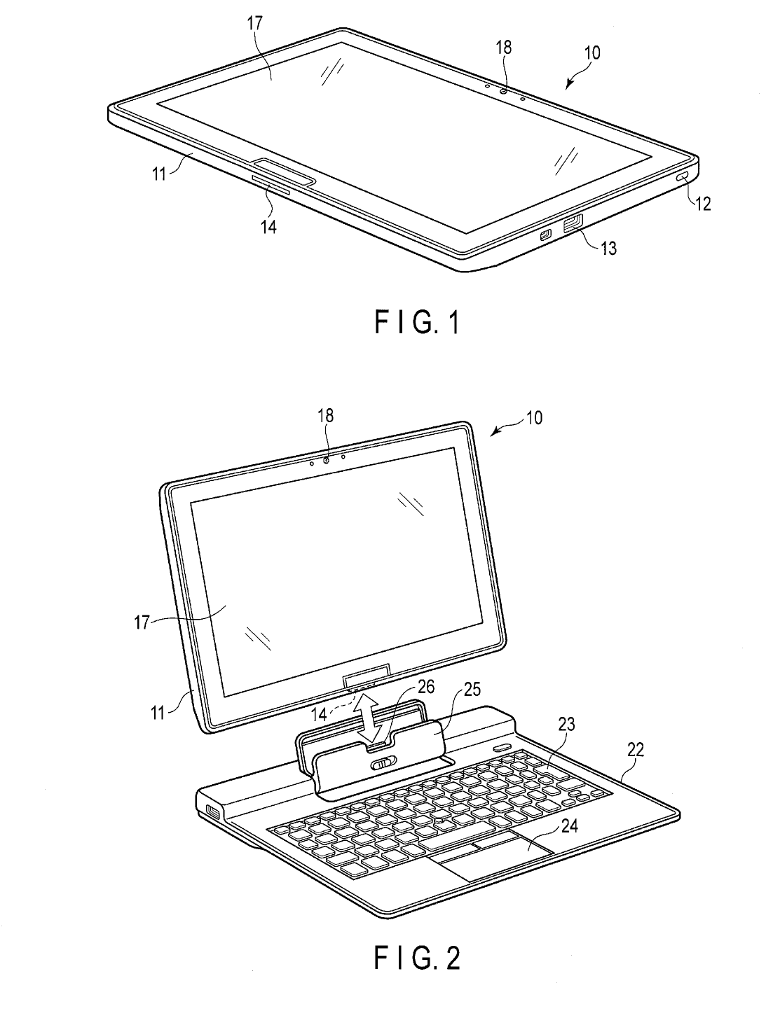

FIG. 2 shows a relationship between the main body 11 and the base 22.

The base 22 includes a housing in the shape of a thin box. The keyboard 23 and a pointing device (touchpad) 24 are disposed on a top of the housing. Moreover, a rotatable hinge 25 for supporting the main body 11 is mounted on a back end of the top of the housing. The main body 11 can be attached to the rotatable hinge 25 to be detachable therefrom. The rotatable hinge 25 includes a connector 26 for connecting the main body 11 and the base 22 mechanically and electrically. When the lower end of the main body 11 is inserted into the rotatable hinge 25, the connector 14 of the main body 11 is connected to the connector 26 within the rotatable hinge 25. The main body 11 is thereby coupled to the base 22. The connectors 14 and 26 may be USB connectors, or may be dedicated docking ports (docking connectors).

FIG. 3 shows an outside of the electronic apparatus 10 in the case where the electronic apparatus 10 is in the PC style. The main body 11 attached to the base 22 functions as a display monitor of the electronic apparatus 10. When the electronic apparatus 10 is in the PC style shown in FIG. 3, the touchscreen display 17 may be used as an input device, or the keyboard 23 and the touchpad 24 may be used as input devices. That is, the user can operate the electronic apparatus 10 by directly touching the touchscreen display 17, and also can operate the electronic apparatus 10 similarly to a normal PC by using the keyboard 23 and the touchpad 24.

Although an example of using the rotatable hinge 25 and the connectors 14 and 16 as a mechanism for coupling the main body 11 and the base 22 has been described herein, the mechanism is not limited to this example. For example, a fixed hinge attached to the base 22 may be used instead of the rotatable hinge 25.

In addition, when the above-described attachable/detachable keyboard is used as a device including a keyboard instead of the base 22, the attachable/detachable keyboard attached to the main body 11 may be fixed to the main body 11 by magnetic force. As a communication interface between the main body 11 and the attachable/detachable keyboard, a wireless interface such as Bluetooth (registered trademark) may be used instead of a wired interface in which the connectors 14 and 26 are used.

As shown in FIG. 1 to FIG. 3, the main body 11 of the electronic apparatus 10 according to the present embodiment incorporates a imaging device (hereinafter, referred to as a camera) 18 such as a Web camera. The camera 18 is provided at a position near (around) the touchscreen display 17, where it can capture an image of the movement of the user using the electronic apparatus 10, for example, when the electronic apparatus 10 is used in the PC style shown in FIG. 3.

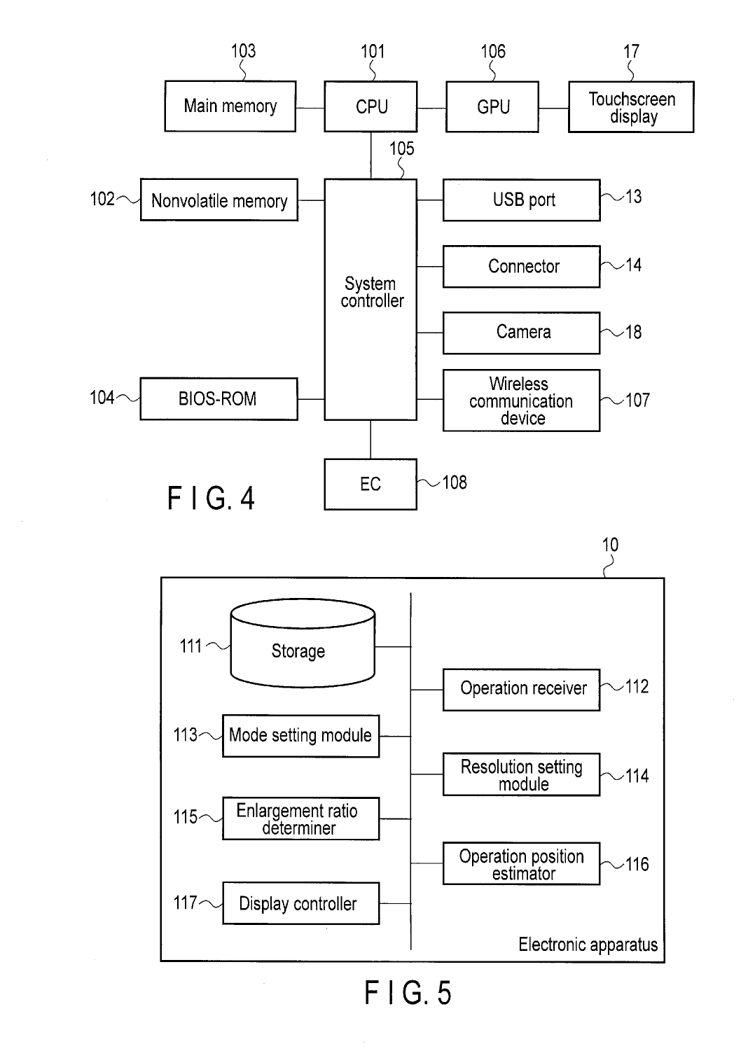

FIG. 4 shows a hardware structure of the electronic apparatus 10. In FIG. 4, a hardware structure of the main body 11 of the electronic apparatus 10 will be mainly described.

The electronic apparatus 10 includes a CPU 101, a nonvolatile memory 102, a main memory 103, a BIOS-ROM 104, a system controller 105, a graphics processing unit (GPU) 106, a wireless communication device 107, an embedded controller (EC) 108, etc., in addition to the USB port 13, the connector 14, the touchscreen display 17, and the camera 18, which are shown in FIG. 1 to FIG. 3.

The CPU 101 is a processor which controls operation of various components in the electronic apparatus 10. The processor includes a processing circuitry. The CPU 101 executes various computer programs loaded from the nonvolatile memory 102, which is a storage device, to the main memory 103. The programs include an operating system (OS), various utility programs, various application programs, etc.

In addition, the CPU 101 also executes a Basic Input/Output System (BIOS) stored in the BIOS-ROM 104. The BIOS is a program for hardware control.

The system controller 105 is a device which connects a local bus of the CPU 101 and various components.

The GPU 106 controls the touchscreen display 17 used as a display monitor of the electronic apparatus 10. Under the control of the GPU 106, various screen images are displayed on the touchscreen display 17. The GPU 106 may be contained in the CPU 101.

The wireless communication device 107 is a wireless LAN controller which performs wireless communication conforming to, for example, the IEEE 802.11 standard.

The EC 108 exerts power management for powering on or off the electronic apparatus 10.

A functional structure of the electronic apparatus 10 will be described with reference to FIG. 5. As described above, various screen images are displayed on the touchscreen display 17, and the electronic apparatus 10 has a function of displaying part or all of the screen image of the touchscreen display enlargingly (hereinafter, referred to as an enlarged display function). In FIG. 5, a functional structure related to the enlarged display function will be mainly described.

As shown in FIG. 5, the electronic apparatus 10 includes storage (a memory) 111, an operation receiver 112, a mode setting module 113, a resolution setting module 114, an enlargement ratio determiner 115, an operation position estimator 116, and a display controller 117.

In the present embodiment, it is assumed that the storage 111 is stored in the above-described nonvolatile memory 102, etc. In addition, although some or all of the operation receiver 112, the mode setting module 113, the resolution setting module 114, the enlargement ratio determiner 115, the operation position estimator 116, and the display controller 117 are functional modules which are implemented when the CPU 111 (computer of the electronic apparatus 10) executes a program (software), each of the modules 112 to 117 may be implemented as hardware such as an integrated circuit (IC), or may be implemented as a combined structure of software and hardware.

It should be noted that the program for implementing some or all of the operation receiver 112, the mode setting module 113, the resolution setting module 114, the enlargement ratio determiner 115, the operation position estimator 116, and the display controller 117 may be installed in the computer of the electronic apparatus 10 through a computer-readable storage medium having stored thereon the program.

In the storage 111, for a resolution set for the touchscreen display 17, setting data indicating an enlargement ratio and an enlargement target range according to the resolution is stored in advance. As the enlargement ratio according to the resolution, in the case where the resolution is set for the touchscreen display 17, a ratio is defined in which the screen image of touchscreen display 17 is displayed enlargedly by the enlarged display function. As the enlargement target range according to the resolution, a range (position) of each of the areas constituting the screen image of the touchscreen display 17 divided by a number according to the resolution is defined. The enlargement target range is used to determine (a range of) an area to be a unit of enlarged display by the enlarged display function.

The operation receiver 112 has a function of receiving the user's operations on the electronic apparatus 10. The operations received by the operation receiver 112 include, for example, an operation of touching the user's finger or the pen to the touchscreen display 17 (hereinafter, referred to as a touch operation), an operation on the keyboard 23 and the touchpad 24, etc.

The mode setting module 113 sets an operation mode of the electronic apparatus 10 in accordance with an operation received by the operation receiver 112. The operation modes set by the mode setting module 113 include a mode for automatically displaying the screen image of the touchscreen display 17 enlargingly (hereinafter, referred to as an automatic enlargement mode).

The resolution setting module 114 sets a resolution of the touchscreen display 17, for example, in accordance with an operation received by the operation receiver 112. The screen image of the touchscreen display 17 is displayed in accordance with the resolution set by the resolution setting module 114.

On the basis of setting data stored in the storage 111 and a resolution set by the resolution setting module 114, the enlargement ratio determiner 115 determines a ratio (enlargement ratio) according to which the screen image of the touchscreen display 17 is displayed enlargedly by the enlarged display function. In addition, on the basis of setting data stored in the storage 111 and a resolution set by the resolution setting module 114, the enlargement ratio determiner 115 determines a range of an area to be a unit of enlarged display by the enlarged display function (enlargement target range).

The operation position estimator 116 estimates a position on the screen image of the touchscreen display 17, where the user is about to perform a touch operation, on the basis of an image of the user captured by the above-described camera 18, when the automatic enlargement mode is set by the mode setting module 113.

The display controller 117 displays the screen image of the touchscreen display 17 enlargingly according to an enlargement ratio determined by the enlargement ratio determiner 115. When the automatic enlargement mode is set by the mode setting module 113 as described above, the display controller 117 specifies an area including a position estimated by the operation position estimator 116 from areas (areas constituting the touchscreen display) to be a unit of enlarged display on the basis of an enlargement target range determined by the enlargement ratio determiner 115, and displays the specified area enlargingly according to an enlargement ratio determined by the enlargement ratio determiner 115.

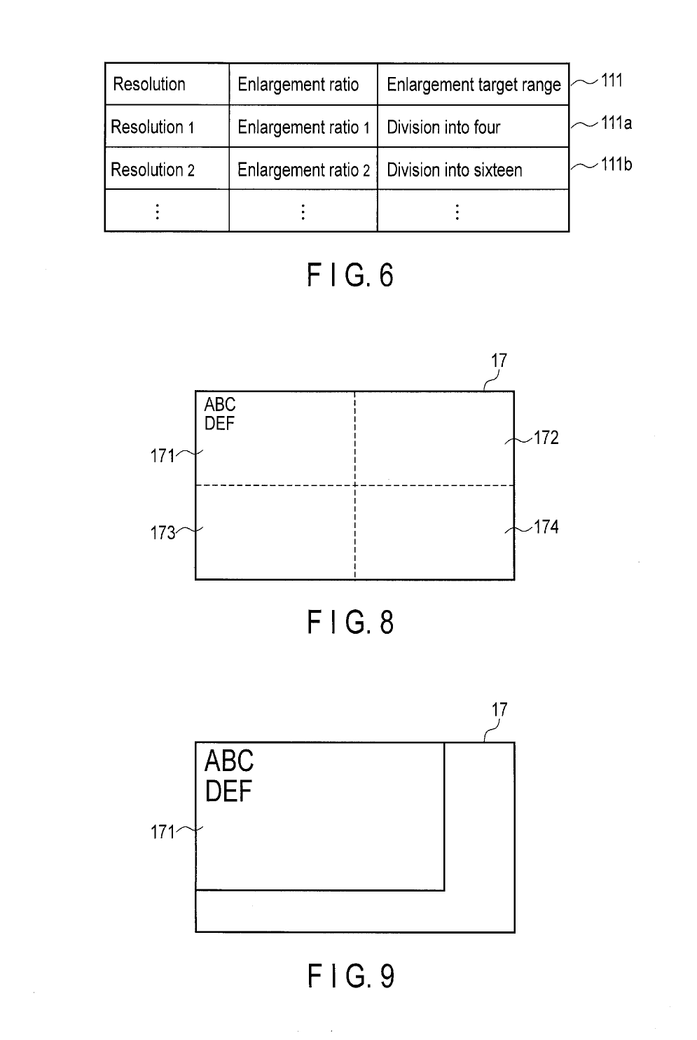

FIG. 6 shows an example of a data structure of the storage 111 shown in FIG. 5. In the storage 111, setting data including (data indicating) an enlargement ratio and an enlargement target range is stored, being associated with a resolution. In the example shown in FIG. 6, setting data items including setting data items 111a and 111b are stored in the storage 111.

The setting data item 111a includes an enlargement ratio “enlargement ratio 1” and an enlargement target range “division into four”, associating them with a resolution “resolution 1”. According to the setting data item 111a, it is indicated that in the case where “resolution 1” is set for the touchscreen display 17, a ratio of enlarged display by the enlarged display function is “enlargement ratio 1”, and (a range of) an area to be a unit of the enlarged display is (a range of) an area obtained by dividing the screen image of the touchscreen display 17 into four. It should be noted that the area obtained by dividing the screen image of the touchscreen display 17 into four is an area obtained by dividing the screen image into four, equally partitioning it into two in each of a longitudinal direction and a lateral direction. The area may an area obtained by dividing the screen image into four by other techniques.

The setting data item 111b includes an enlargement ratio “enlargement ratio 2” and an enlargement target range “division into sixteen”, associating them with a resolution “resolution 2”. According to the setting data item 111b, it is indicated that in the case where “resolution 2” is set for the touchscreen display 17, a ratio of enlarged display by the enlarged display function is “enlargement ratio 2”, and (a range of) an area to be a unit of the enlarge display is (a range of) an area obtained by dividing the screen image of the touchscreen display 17 into sixteen. It should be noted that the area obtained by dividing the screen image of the touchscreen display 17 into sixteen is an area obtained by dividing the screen image into sixteen, equally partitioning it into four in each of a longitudinal direction and a lateral direction. The area may be an area obtained by dividing the screen image into sixteen by other techniques.

In the present embodiment, it is assumed that an enlargement target range included in setting data is defined, such that as a resolution associated with the enlargement target range is higher, the number of areas into which division is made is larger.

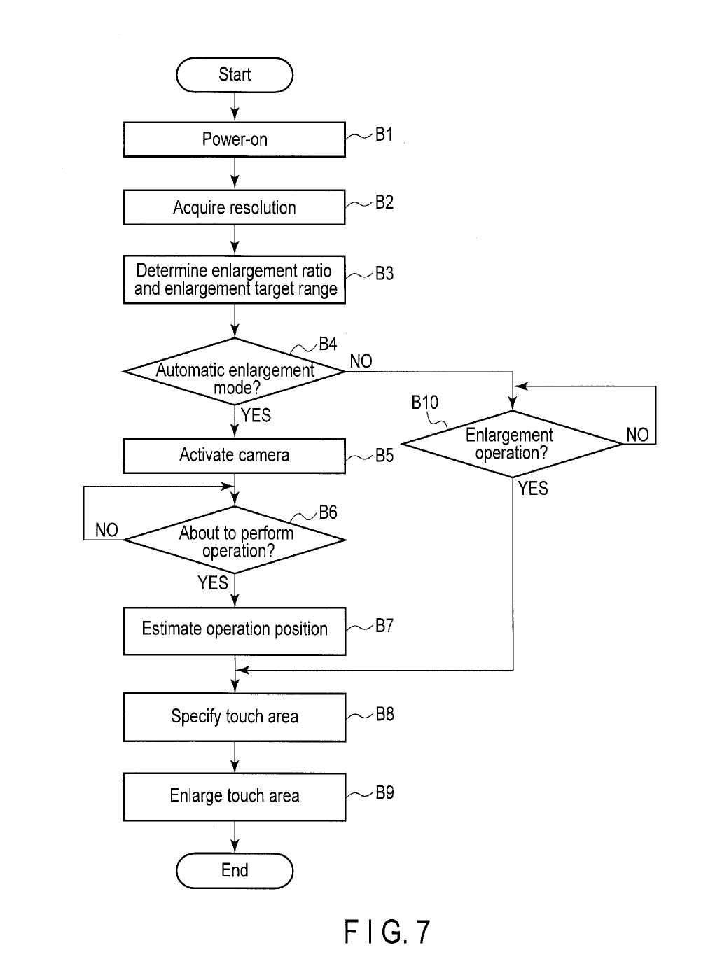

Next, a procedure of the electronic apparatus 10 by which the screen image of the touchscreen display 17 is displayed enlargedly by the above-described enlarged display function will be described with reference to a flowchart of FIG. 7.

First, when the power button 12 provided on the side surface of the main body 11 of the electronic apparatus 10 is pressed by the user, the electronic apparatus 10 is powered on (block B1).

Then, the enlargement ratio determiner 115 acquires a resolution of the touchscreen display 17 set by the resolution setting module 114 (block B2). The resolution set for the touchscreen display 17 can be acquired from, for example, the operating system.

The enlargement ratio determiner 115 determines an enlargement ratio and an enlargement target range according to the acquired resolution, referring to the storage 111 (block B3). Specifically, the enlargement ratio determiner 115 determines an enlargement ratio and an enlargement target range which are included in setting data, being associated with the acquired resolution, of enlargement ratios and enlargement target ranges included in respective setting data items stored in the storage 111. As an enlargement target range determined by the enlargement ratio determiner 115, a range (position) of each of areas obtained by dividing the screen image of the touchscreen display 17 into four or sixteen is defined.

An enlargement ratio and an enlargement target range determined by the enlargement ratio determiner 115 are set in the electronic apparatus 10.

Here, in the electronic apparatus 10 according to the present embodiment, the automatic enlargement mode can be set as an operation mode of the electronic apparatus 10 in accordance with an operation received by the operation receiver 112 (that is, the user's operation on the electronic apparatus 10).

Therefore, in the electronic apparatus 10, it is determined whether or not the automatic enlargement mode is set as the operation mode of the electronic apparatus 10 (block B4).

When it is determined that the automatic enlargement mode is set (YES in block B4), the camera 18 provided in the main body 11 of the electronic apparatus 10 is activated (block B5). An image of the user using the electronic apparatus 10 in front of the electronic apparatus 10 (the camera 18) can be thereby captured by using the camera 18.

The operation position estimator 116 acquires the image of the user captured by the camera 18 (hereinafter, referred to as a user image). The operation position estimator 116 determines whether or not the user is about to perform a touch operation on the touchscreen display 17 on the basis of, for example, a position of (a finger of) the user included in the user image (block B6). In this case, a relative positional relationship between the touchscreen display 17 and the camera 18 is held in advance in the electronic apparatus 10, and when it can be determined that the user's finger is approaching the touchscreen display 17 in the user image, it is determined that the user is about to perform a touch operation.

When it is determined that the user is not about to perform a touch operation (NO in block B6), the process of block B6 is repeated. That is, the electronic apparatus 10 stands by until the user is about to perform a touch operation.

On the other hand, when it is determined that the user is about to perform a touch operation (YES in block B6), the operation position estimator 116 estimates a position on the screen image of the touchscreen display 17 (hereinafter, referred to as an operation position) where the user is about to perform a touch operation (block B7). It should be noted that the operation position is estimated on the basis of the position of the user's finger included in the user image, the above-described relative positional relationship between the touchscreen display 17 and the camera 18, etc.

Next, the display controller 117 specifies an area (hereinafter, referred to as a touch area) including the position estimated by the operation position estimator 116 (that is, a position where a touch operation is estimated to be performed) on the basis of the enlargement target range (for example, a range of each of areas obtained by dividing the screen image of the touchscreen display 17 into four or sixteen, etc.) determined by the enlargement ratio determiner 115 (block B8). The touch area is specified from areas to be a unit of enlarged display defined in the enlargement target range determined by the enlargement ratio determiner 115 (areas constituting the touchscreen display).

Although it has been herein explained that the touch area is specified on the basis of the enlargement target range determined by the enlargement ratio determiner 115, for example, an area of a certain range including the operation position estimated by the operation position estimator 116 may be specified as the touch area.

The display controller 117 displays the specified touch area enlargingly according to the enlargement ratio determined by the enlargement ratio determiner 115 (block B9).

Here, an example of a display screen image displayed enlargedly in the present embodiment will be described with reference to FIG. 8 and FIG. 9.

It is assumed that as shown in FIG. 8, a range of each of four areas 171 to 174 obtained by dividing the screen image of the touchscreen display 17 into four is defined in the enlargement target range determined by the enlargement ratio determiner 115.

In this case, when the touch area including the operation position estimated by the operation position estimator 116 is the area 171, the area 171 is displayed enlargedly as shown in FIG. 9.

It should be noted that when at least one area (here, the area 171) are displayed enlargedly, the display of the other areas (here, the areas 172 to 174) is maintained. Thus, on the screen image of the touchscreen display 17, the enlarged area 171 is displayed while being superposed on parts of the areas 172 to 174.

Although it has been herein explained that only the area 171, which is one of the areas 171 to 174, is displayed enlargedly, areas may be displayed enlargedly when the above-described operation position extends over the areas.

The enlarged display of the area 171 shown in FIG. 9 may be cancelled, for example, when a predetermined operation is performed on the touchscreen display 17 after the process of block B9 is carried out (that is, when the predetermined operation is received by the operation receiver 112). It should be noted that the predetermined operation for cancelling the enlarged display is not limited to operations on the touchscreen display 17, but may be operations performed by using, for example, the keyboard 23, the touchpad 24, and the mouse.

In addition, the enlarged display may be cancelled, when the process of block B6 is carried out again after the process of block B9 is carried out and it is determined that the user is not about to perform a touch operation.

Returning to FIG. 7 again, when it is determined in block B4 that the automatic enlargement mode is not set (NO in block B4), a process of displaying an area including a position where an operation for indicating enlarged display (hereinafter, referred to as an enlargement operation) has been performed enlargingly is carried out. The enlargement operation includes an operation of performing a touch operation twice on the touchscreen display 17 with a short time interval (double-tap operation), etc. The enlargement operation is not limited to operations on the touchscreen display 17, but may be operations performed by using, for example, the keyboard 23, the touchpad 24, and the mouse.

In this case, it is determined whether or not the enlargement operation is received by the operation receiver 112 (block B10). When it is determined that the enlargement operation is not received (NO in block B10), the process of block B10 is repeated. That is, the electronic apparatus 10 stands by until the enlargement operation is received.

On the other hand, when it is determined that the enlargement operation is received (YES in block B10), the above-described processes of blocks B8 and B9 are carried out with a position where the enlargement operation (double-tap operation) has been performed regarded as the operation position. Thus, even if the automatic enlargement mode is not set, the user can display an area enlargingly by performing an enlargement operation on the desired area of the screen image of the touchscreen display 17.

Although not shown in FIG. 7, when the automatic enlargement mode is set in the electronic apparatus 10, the processes in and after block B6 are repeated after the processes shown in FIG. 7 are ended.

It is assumed that when (the setting of) the operation mode of the electronic apparatus 10 is changed (for example, the setting of the automatic enlargement mode is cancelled), the processes in and after block B4 are carried out. Moreover, it is assumed that when (the setting of) the resolution of the touchscreen display 17 is changed, the processes in and after block B2 are carried out.

As described above, in the present embodiment, an enlargement ratio according to a resolution set for the touchscreen display 17 is determined on the basis of setting data stored in the storage 111, and the screen image of the touchscreen display 17 is displayed enlargedly according to the enlargement ratio. In the present embodiment, according to such a structure, even if the resolution of the touchscreen display 17 is changed, the screen image can be displayed enlargedly according to an appropriate enlargement ratio according to the resolution, whereby the visibility of the touchscreen display 17 to the user can be improved.

In addition, in the present embodiment, at least one area of areas constituting the screen image of the touchscreen display 17 divided by a number according to a resolution set for the touchscreen display 17 is displayed enlargedly. In the present embodiment, according to such a structure, enlarged display can be performed in an appropriate range according to the resolution of the touchscreen display 17, whereby the visibility of touchscreen display 17 to the user can be improved.

Moreover, in the present embodiment, when the automatic enlargement mode is set in the electronic apparatus 10, an area including a position where a touch operation is estimated to be performed on the basis of an image of the user captured by the camera 18 is displayed enlargedly. In the present embodiment, according to such a structure, an area where the user is about to perform a touch operation can be displayed enlargedly, whereby a comfortable environment in which the user easily performs a touch operation all the time can be provided.

In addition, in the present embodiment, when the automatic enlargement mode is not set, an area including a position where a predetermined operation has been performed is displayed enlargedly. In the present embodiment, according to such a structure, the user can manually designate an area and cause the area to be displayed enlargedly.

Although it has been explained in the present embodiment that an enlargement ratio and an enlargement target range according to the resolution of the touchscreen display 17 are determined, it is also possible that an enlargement target range (that is, a range to be a unit of enlarged display) is constant and (the setting of) an enlargement ratio is changed in accordance with the resolution. That is, the structure described in the present embodiment may be changed as appropriate, as long as enlarged display can be performed according to an appropriate ratio according to the resolution of the touchscreen display 17.

Moreover, although it has been explained in the present embodiment that an enlargement ratio and an enlargement target range are determined using setting data stored in advance in the storage 111, the enlargement ratio and the enlargement target range may be calculated from the resolution of the touchscreen display 17 using a function prepared in advance, etc.

In addition, although it has been explained in the present embodiment that the automatic enlargement mode is set in accordance with an operation received by the operation receiver 112 (that is, the user's operation), the automatic enlargement mode may be automatically set, for example, when the resolution of the touchscreen display 17 is changed.

Further, although it has been explained that the electronic apparatus 10 according to the present embodiment is implemented as a two-in-one PC, the electronic apparatus 10 may be implemented as other electronic apparatuses including a touchscreen display, for example, a tablet computer, a smartphone, and a personal digital assistant (PDA).

Moreover, the present embodiment may be applied to an electronic apparatus not including a touchscreen display, for example, a notebook personal computer (PC). In this case, for example, the user's line of sight is detected by analyzing an image of the user's eyes captured by the camera 18, and an area including a position on a screen image of a display corresponding to the detected line of sight is specified, whereby the specified area can be displayed enlargedly according to an enlargement ratio according to a resolution of the display. Further, an area corresponding to a position designated by a pointer (mouse pointer) on the screen image of the display may be displayed enlargedly.

In addition, although it has been explained in the present embodiment that the electronic apparatus 10 includes the storage 111, the storage 111 may be provided in an external server device, etc. In this case, it suffices if setting data is acquired (received) from the external server device, etc., when the above-described process of B3 shown in FIG. 7 is carried out.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a display;
a memory configured to store resolution setting data comprising multiple enlargement ratios each of which is associated with a resolution to be set on the display; and
circuitry configured to determine a first enlargement ratio for a designated resolution on the display based on the resolution setting data, and display a screen image on the display at the first enlargement ratio.

2. The electronic apparatus of claim 1, wherein the resolution setting data further indicates divided areas constituting a screen image on the display, the screen image on the display divided by a number based on the resolution setting data for the designated resolution on the display, and
the circuitry is further configured to display at least one area of the divided areas constituting the screen image on the display at the first enlargement ratio based on the resolution setting data for the designated resolution on the display.

3. The electronic apparatus of claim 2, further comprising a camera for capturing an image of a user using the electronic apparatus,
wherein the display comprises a touchscreen display configured to detect a touch operation by the user, and
the circuitry is further configured to, when an automatic enlargement mode is set for displaying the screen image, display an area including an estimated position at the first enlargement ratio where the touch operation is performed based on an image of the user captured by the camera.

4. The electronic apparatus of claim 3, wherein the circuitry is further configured to, when the automatic enlargement mode is not set, display an area including a position at the first enlargement ratio where a predetermined operation is performed.

5. A method executed by an electronic apparatus comprising a display and a memory configured to store resolution setting data comprising multiple enlargement ratios, each of which is associated with a resolution to be set on the display, the method comprising:
determining a first enlargement ratio for a designated resolution on the display based on the resolution setting data; and
displaying a screen image on the display at the first enlargement ratio.
